(19) United States
(12) Patent Application Publication
(10) Pub. No.: US 2012/0018472 A1
(43) Pub. Date: Jan. 26, 2012

(54) HOLDER FOR TABLET PERSONAL DIGITAL ASSISTANT

(75) Inventor: Tsutomu TOTANI, Aichi (JP)

(73) Assignee: Beat-Sonic Co., Ltd., Nisshin-shi (JP)

(21) Appl. No.: 12/883,704

(22) Filed: Sep. 16, 2010

(30) Foreign Application Priority Data
Jul. 22, 2010 (JP) 2010-164475

(51) Int. Cl. B60R 7/00

(52) U.S. Cl. 224/276

(57) ABSTRACT

A holder for a tablet personal digital assistant, includes a body formed into a tabular shape and having an opening into which a lower arc portion formed on a steering wheel rim of a parked vehicle is insertable, a hitch protrusion which is provided so as to protrude into the opening, the hitch protrusion hitched to an inner circumferential part of the arc portion inserted into the opening, thereby holding the body on the arc portion, and a lock portion located in the rear of the hitch protrusion when the body has been held on the arc portion, the lock portion locking a side edge of the assistant. The tablet personal digital assistant is held on the steering wheel of the vehicle when the body has been held on the arc portion and the side edge of the assistant has been locked by the lock portion.

### CROSS-REFERENCE TO RELATED APPLICATIONS

This application is based upon and claims the benefit of priority from the prior Japanese Patent Application No. 2010-164475, filed on Jul. 22, 2010, the entire contents of which are incorporated herein by reference.

### BACKGROUND

1. Technical Field

The present disclosure relates to a holder for a tablet personal digital assistant, which holds a tablet personal digital assistant on a steering wheel of a parked vehicle.

2. Related Art

There have recently been commercially provided tablet personal digital assistants which comprise a liquid crystal display and application software on which a user can read an electronic book. The liquid crystal display serves not only as a display but as a multi-touch screen or multi-touch panel. The multi-touch panel is operated so that an electronic book is downloaded. The contents of the electronic book are displayed on a screen of the liquid crystal display or the multi-touch screen is operated so that pages of the electronic book are turned thereby to be read. Japanese patent application publication, JP-A-2009-211706 discloses one of the above-described tablet personal digital assistants.

When a driver parks his/her car for rest to try to read an electronic book by the use of a tablet personal digital assistant while taking the driver's seat, the driver could easily operate the multi-touch screen if the tablet personal digital assistant is held on a steering wheel. As a result, the driver could read comfortably.

However, no means for holding a tablet personal digital assistant on a steering wheel has been commercially available. Accordingly, when reading an electronic book while taking the driver's seat, the driver holds the tablet personal digital assistant in his/her one hand. The driver then operates the multi-touch screen with the other hand, pressing the assistant onto the steering wheel. However, when reading an electronic book in the above-described manner, the driver inevitably keeps holding the tablet personal digital assistant in his/her hand during reading, feeling bothersome. The driver cannot get away from the botheration when reading at the driver's seat.

### SUMMARY

Therefore, an object of the present disclosure is to provide a holder for the tablet personal digital assistant, which can hold the tablet personal digital assistant on the steeling wheel of a parked vehicle without the driver keeping holding the tablet personal digital assistant, and which is not voluminous and has a simple structure suitable for being equipped in the vehicle.

The present disclosure provides a holder for a tablet personal digital assistant, comprising a body formed into a flat shape and having an opening into which a lower arc portion formed on a steering wheel rim of a parked vehicle is insertable; a hitch protrusion which is provided so as to protrude into the opening, the hitch protrusion catching an inner circumferential part of the arc portion inserted into the opening, thereby holding the body on the arc portion; and a lock portion located in the rear of the hitch protrusion when the body has been held on the arc portion, the lock portion locking a side edge of the assistant, wherein the tablet personal digital assistant is held on the steering wheel of the vehicle when the body has been held on the arc portion and the side edge of the assistant has been locked by the lock portion.

### BRIEF DESCRIPTION OF THE DRAWINGS

In the accompanying drawings:

FIG. 1 is a plan view of the holder for a tablet personal digital assistant in accordance with one embodiment;

FIG. 2 is a sectional view taken along 2-2 in FIG. 1;

FIG. 3 schematically illustrates the holder held on the steering wheel;

FIG. 4 schematically illustrates the holder mounted on a steering wheel and a tablet personal digital assistant held on the holder with the lower edge of the assistant being locked;

FIG. 5 schematically illustrates the holder mounted on another steering wheel;

FIG. 6 is a perspective view of the holder in accordance with a second embodiment; and

FIG. 7 is a plan view of the holder in accordance with a third embodiment.

### DETAILED DESCRIPTION

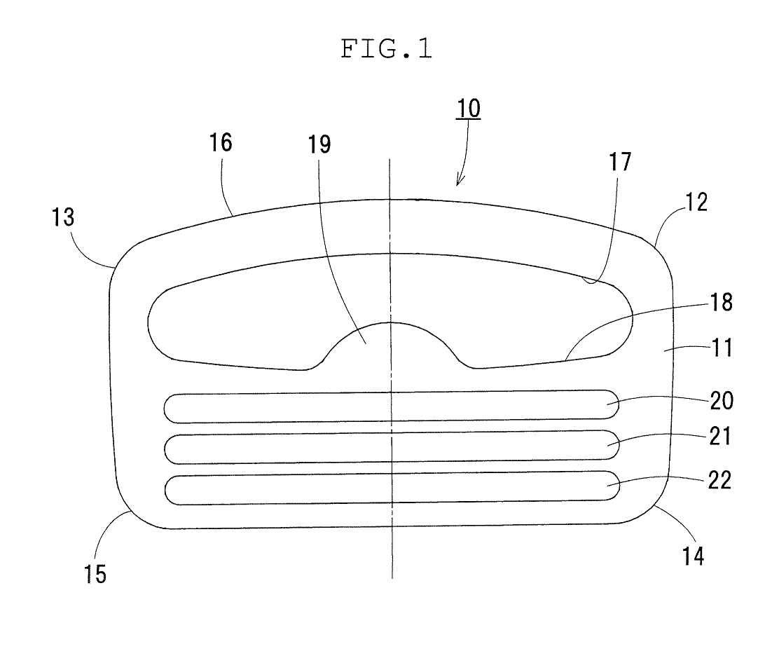

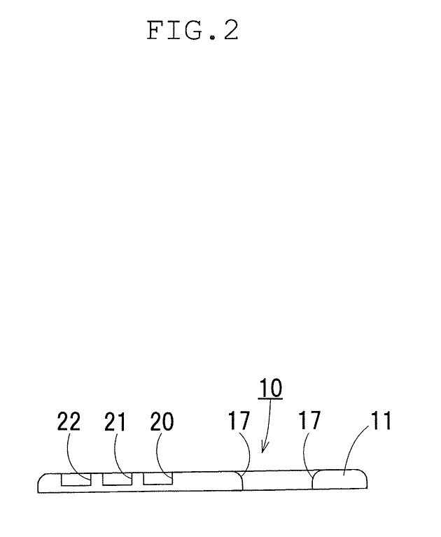

Several embodiments will be described with reference to the accompanying drawings. Referring to FIGS. 1 to 5, the holder 10 for a tablet personal digital assistant, in accordance with the first embodiment is shown. The holder 10 includes a body 11 made of a flat wooden board and has a generally rectangular planar shape. The body 11 has four corners which are chamfered and a front edge 16 which is gently curved frontward.

The body 11 includes a front half formed with an opening that is horizontally long and a rear edge 18 having a middle part having a generally semicircular convex hitch protrusion 19 which is formed so as to protrude into the opening 17. Three equally-spaced horizontal grooves 20, 21 and 22 each of which serves as a lock portion are formed in a rear half of the body 11. The grooves 20-22 extend in the right-left direction relative to the body 11.

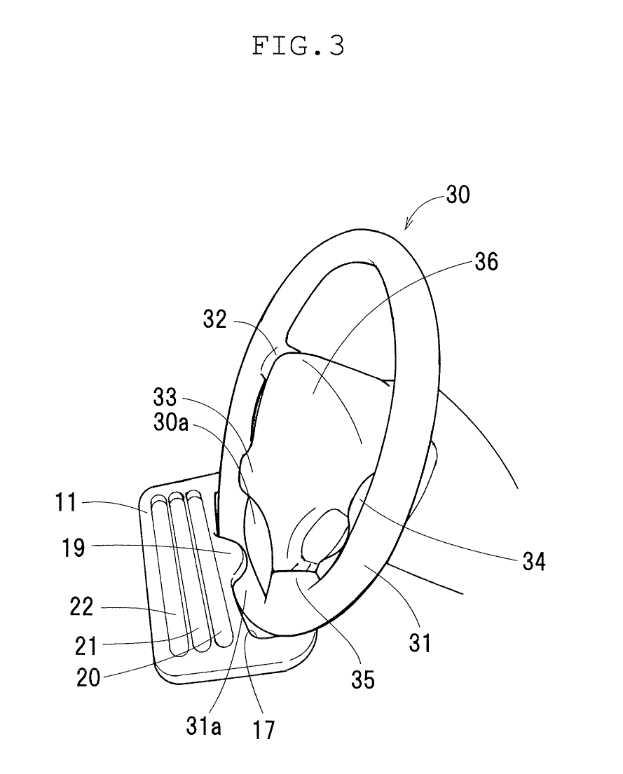

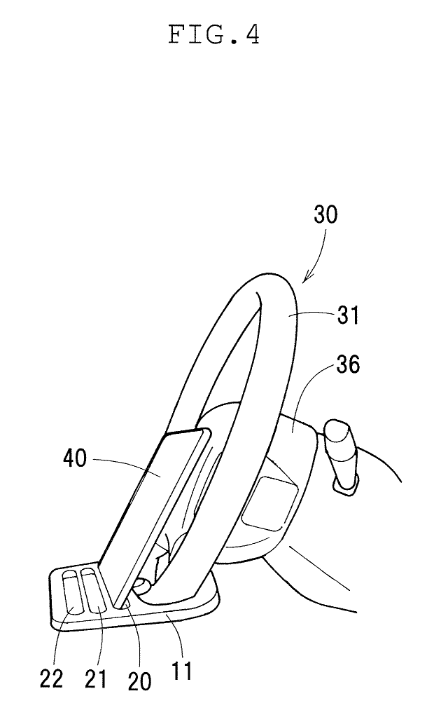

The usage of the holder 10 will now be described with reference to FIGS. 3 to 5. In the following description, a vehicle 30 such as automobile has a steering wheel 30 which includes a rim 31 as shown in FIG. 4. The rim 31 includes a lower arc portion 31a. A tablet personal digital assistant 40 has a book size or is 242.8 mm high, 189.7 mm wide and 13.4 mm deep.

When wishing to read an electronic book using the tablet personal digital assistant while being seated on the driver's seat during parking, a driver inserts the lower arc portion 31a of the rim 31 of the steering wheel 30 through the opening 17 of the holder 10 to hitch the hitch protrusion 19 to the arc portion 31a of the rim 30. Since the opening 17 and the hitch protrusion 19 have predetermined shapes and dimensions respectively, the holder body 11 is mounted on the lower arc portion 31a of the rim 31 so as to be substantially in parallel to the floor of the vehicle as shown in FIG. 3 when the hitch protrusion 19 is hitched to the lower arc portion 31a.

Subsequently, a lower edge of the tablet personal digital assistant 40 is inserted into one 20 of the three grooves 20-22 of the holder body 11 thereby to be locked in the groove 20, as shown in FIG. 4. Each of the grooves 20-22 has predetermined length, width and depth so that right and left side edges of the tablet personal digital assistant 40 are locked as well as the lower edge thereof when the assistant 40 is disposed sideways. When the tablet personal digital assistant 40 is thus locked by a lower edge of the groove 20 of the holder 10, the assistant 40 can be placed against a hub of the steering wheel.

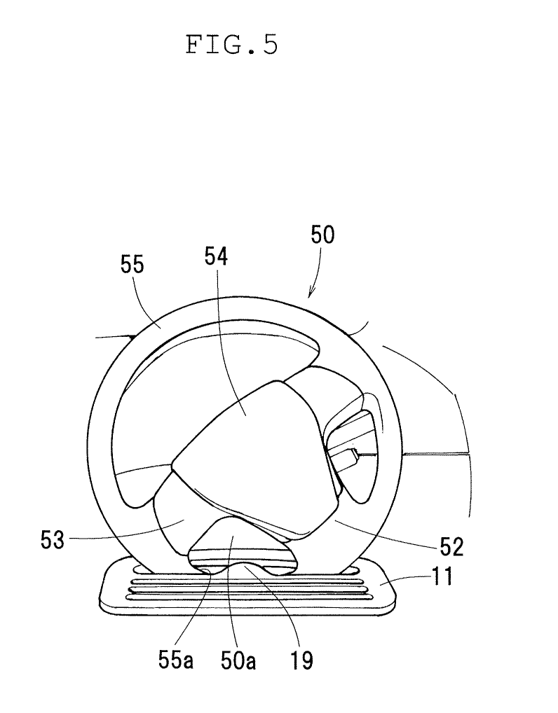

The steering wheel 30 as shown in FIGS. 3 and 4 has four spokes 32 to 35. When the steering wheel 30 assumes a neutral steering position where the vehicle travels straight ahead, the space 30a through which the hitch protrusion 19 is insertable is defined between hub 36 and the rim 31. On the other hand, another steering wheel 50 as shown in FIG. 5 has three spokes 51 to 53. No space is defined between a hub 54 and a rim 55 when the steering wheel assumes a neutral steering position. In this case, the steering wheel 50 is turned clockwise or counterclockwise so as to be displaced from the neutral steering position as shown in FIG. 5. Consequently, since a space 50a through which the hitch protrusion 19 is insertable is defined between the hub 54 and the rim 55, the holder body 11 can be hitched to a lower arc part 55a of the rim 55.

According to the holder 10 as described above, the body 11 thereof is hitched to the lower arc portion 31a or 55a of the steering wheel rim 31 or 55 of the parked vehicle, and the side edge of the tablet personal digital assistant 40 is inserted into the horizontal groove 20, 21 or 22 thereby to be locked. As a result, the tablet personal digital assistant 40 can be placed against the hub 36 or 54 of the steering wheel 30 or 50. Accordingly, the driver need not keep holding the tablet personal digital assistant 40 with his/her hand when reading an electronic book or the like while being seated on the driver's seat. Thus, the driver can read with ease.

Since the holder 10 is formed into the flat plate shape, the holder 10 is not bulky and can be kept in the vehicle interior using a small space, whereupon the holder 10 is convenient. Furthermore, the holder 10 has a simple structure since the flat plate-shaped body 11 of the holder 10 has only the opening 17, the hitch protrusion 19 and the horizontal grooves 20 to 22. Consequently, the holder 10 can be manufactured at lower costs.

The body 11 of the holder 10 has the plural horizontal grooves 20 to 22. When the table personal digital assistant 40 is to be placed against the steering wheel 30, the side edge of the assistant 40 is selectively locked one of the horizontal grooves 20 to 22. Consequently, the tablet personal digital assistant 40 can be placed against the steering wheel 30 or 50 at such an angle that the driver can read easily.

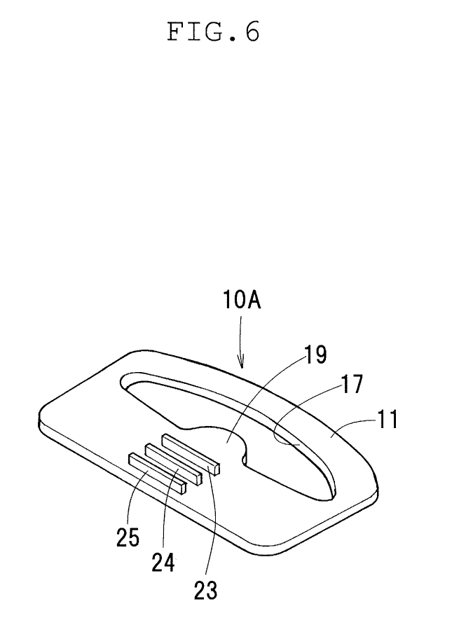

FIG. 6 illustrates a second embodiment. The body 11 of the holder 10 is formed with the horizontal grooves 20 to 22 in order that the side edge of the tablet personal digital assistant 40 may be locked by any one of the grooves 20-22, in the foregoing embodiment. On the other hand, the holder 10A according to the second embodiment is provided with three convex lines 23 to 25 as the means for locking the side edge of the tablet personal digital assistant 40, instead of the horizontal grooves 20 to 22, as shown in FIG. 6. In the other respects, the holder 10A according to the second embodiment is the same as the holder 10 according to the first embodiment. Accordingly, identical or similar parts in the second embodiment are labeled by the same reference symbols as those in the first embodiment, and the description of these identical parts will be eliminated.

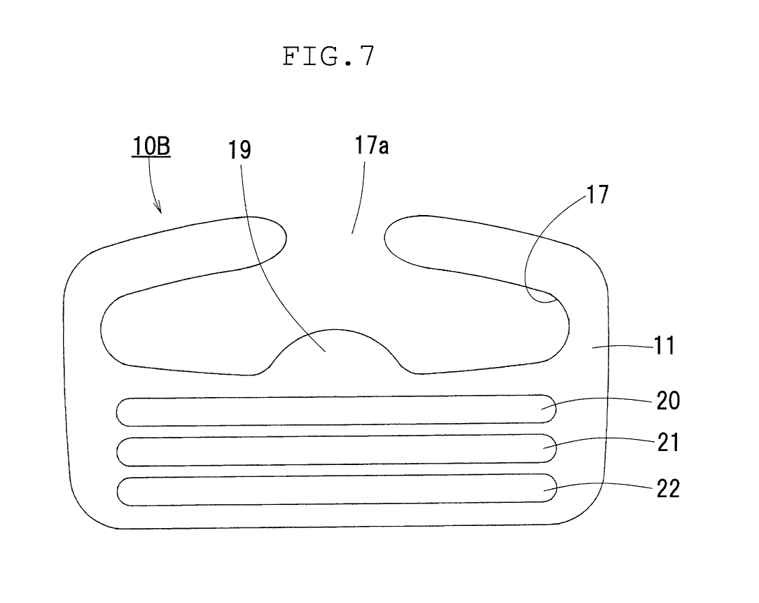

FIG. 7 illustrates a third embodiment. The opening 17 is horizontally long and closed in the holders 10 and 10A in accordance with the first and second embodiments respectively. On the other hand, in the third embodiment, the holder 10B is formed with the opening 17 having a centrally located notch 17a. Thus, the design of the holder 10B can be changed by changing the shape of the opening 17 or the shape of the hitch protrusion 19.

In the other respects, the holder 10B according to the third embodiment is the same as the holder 10 according to the first embodiment. Accordingly, identical or similar parts in the third embodiment are labeled by the same reference symbols as those in the first embodiment, and the description of these identical parts will be eliminated.

The foregoing description and drawings are merely illustrative and are not to be construed in a limiting sense. Various changes and modifications will become apparent to those of ordinary skill in the art. All such changes and modifications are seen to fall within the scope as defined by the appended claims.

What is claimed is:

1. A holder for a tablet personal digital assistant, comprising:
a body formed into a flat shape and having an opening into which a lower arc portion formed on a steering wheel rim of a parked vehicle is insertable;
a hitch protrusion which is provided so as to protrude into the opening, the hitch protrusion catching an inner circumferential part of the arc portion inserted into the opening, thereby holding the body on the arc portion; and
a lock portion located in the rear of the hitch protrusion when the body has been held on the arc portion, the lock portion locking a side edge of the assistant,
wherein the tablet personal digital assistant is held on the steering wheel of the vehicle when the body has been held on the arc portion and the side edge of the assistant has been locked by the lock portion.

2. The holder according to claim 1, wherein the body is formed with a groove serving as the lock portion.

3. The holder according to claim 2, wherein a plurality of the grooves is formed so as to extend in parallel.
